(19) United States
(12) Patent Application Publication
(10) Pub. No.: US 2016/0033411 A1
(43) Pub. Date: Feb. 4, 2016

(54) METHODS AND COMPOSITIONS RELATING TO STORM-BASED PATTERNING

(71) Applicant: President and Fellows of Harvard College, Cambridge, MA (US)

(72) Inventor: Robert Barish, Tokyo (JP)

(73) Assignee: President and Fellows of Harvard College, Cambridge, MA (US)

(21) Appl. No.: 14/811,638

(22) Filed: Jul. 28, 2015

Related U.S. Application Data
(60) Provisional application No. 62/030,546, filed on Jul. 29, 2014.

(51) Int. Cl. G01N 21/64

(52) U.S. Cl. CPC G01N 21/6428; G01N 2021/6439

(57) ABSTRACT

This disclosure provides methods for generating super-resolution patterns of molecules on substrates.

### RELATED APPLICATIONS

This application claims the benefit of U.S. Provisional Application No. 62/030,546 filed Jul. 29, 2014, the entire contents of which are incorporated by reference herein.

### SUMMARY OF INVENTION

This disclosure provides methods and compositions for patterning substrates in two or three dimensions with agents including molecules and functionalities of interest.

The methods provided herein employ various approaches for patterning substrates having diffraction limited areas or located in diffraction limited areas.

Certain methods provided herein are based on photoswitching of dyes and the ability to preserve select dyes, based for example on their position, while effectively inactivating other dyes. These methods are referred to herein as negative patterning methods. In these methods, the ability to photoswitch, detect and localize individual dyes (or dye molecules, as the terms are used interchangeably herein) is exploited in order to selectively inactivate (e.g., by photobleaching) certain dyes in a population of dyes, while preserving other dyes in the same population. Dyes to be inactivated are distinguished from dyes to be preserved typically based on their two-dimensional or three-dimensional position on or in a substrate or surface. These methods involve co-ordination between fluorescent detection systems and irradiation systems, including the use of ultrashort (e.g., <200 femtoseconds) high power density irradiation systems, in order to inactivate single dyes in a short time frame. These systems are capable of emitting single isolated pulses or a plurality of pulses in a total time duration of below a threshold value (e.g. ˜200 femtoseconds). In some instances, one or two pulses of total duration of <200 femtoseconds may be sufficient.

These methods can be used to pattern a surface, such as a surface of a substrate. As used herein, to pattern a surface means to selectively deposit an agent on a portion of a surface, typically in a predetermined manner. The surface or the portion of the surface may have dimensions that are less than the diffraction limit of a particular detection system. Thus, the methods facilitate the patterning of a surface at very high resolution (i.e., at very small dimensions), such as for example on the nanometer scale. The ability to pattern a surface at this scale is useful in for example lithography or other applications which benefit from high resolution deposition of agents.

The select region of the substrate to be patterned may be smaller than the diffraction limited region. The select region of the substrate to be patterned may (or may not) have features or sections that locally have an area (or volume) that are smaller than the area (or volume) of the diffraction limited region to which they correspond. In some embodiments, the select region(s) to be patterned is not smaller than a diffraction limited region, and instead it may contain features (which may or may not be connected (adjacent) to each other) which are smaller than the immediate diffraction limited region. Whether a dye is located in an arbitrary two- or three-dimensional select region (which may be referred to herein as a stencil, or “inside a stencil”, or defined by a stencil, FIG. 1) is determined based on the precision and accuracy with which the dye can be observed using super-resolution microscopy. Accordingly, patterning stencils with geometrically defined features at size scales below the diffraction limit may be used.

It is to be understood that the negative patterning approaches described herein may be automated and may employ a charge-coupled device (CCD) or electron-multiplying charge-coupled device (EMCCD) camera. The method may also employ a laser spot illuminator or a Digital Micromirror Device (DMD) array. If a DMD array is used, multiple diffraction limited regions may be monitored and patterned simultaneously (or in parallel).

In some embodiments, the negative patterning approaches described herein may be used to deposit a functional group or a moiety, referred to generically as an agent. In some embodiments, the functional group or the moiety is a chemical handle. In some embodiments, the functional group or the moiety is biotin, avidin, or a nanoparticle. In some embodiments, the functional group or the moiety is an alkyne or azide (e.g., used for “click chemistry”). In some embodiments, the functional group or moiety is used to attach a cargo to the substrate. The cargo may be chemical compounds typically used in lithography in the semi-conductor industry. An example of such a chemical compound is PDMS or PMMA. In some embodiments, the functional group or moiety is a nanowire or a nanoparticle, such as those used in lithography.

In some embodiments, the select region of the substrate is a select area or a select volume of the substrate. The select region may be a region or a pattern predetermined by an end user (e.g., a region the end user wishes to deposit a particular cargo of interest in or on). The region may be an area or a volume. The pattern may be two-dimensional or three-dimensional. In the latter context, the substrate may be a cell or other three dimensional moiety.

When using the methods to pattern in three-dimensions, a point source of light may be assigned an {x,y,z} 3-space coordinate. The decision is then made whether to destroy the pi-conjugated system of a dye at that position using for example a <200 femtosecond pulse (or combined pulses) of radiation from a femtosecond laser. The dye, which may be without limitation Cy5, can be scattered on any two-dimensional surface in a three-dimensional space. For example, one could do random sequential addition of large nanoparticles that pack a three-dimensional space, or one could coat the microtubule network of a cell with dyes.

In some instances, the diffraction-limited region comprises a plurality of dyes bound relatively uniformly throughout its area or volume. In this way, a substrate may be prepared to comprise dyes bound to one or more of its surfaces and one of more of its volumes, and may be treated to create super-resolution patterns as provided herein. The dyes bound to the substrate may be identical to each other or they may be different. If different, there may be 2-1000 populations of dyes attached to the substrate. Any given diffraction limited region may comprise 1-1000 populations of dyes. In some instances, the dyes may be anchored to a substrate such as a coverslip, using any attachment means such as but not limited to epoxy. Any suitable method for attaching the dyes to a substrate is contemplated by the disclosure. Several such methods are known.

For example, dyes can be “targeted” to specific areas or regions (such as within a stencil) including without limitation molecular structures (such as those in a cell) via conjugation to an antibody or aptamer or other binding moiety that binds such areas, regions, molecular structures, etc. This is particularly relevant where patterning inside a cell is desired. In these instances, chemical handles may be attached via the Stochastic Optical Reconstruction Microscopy (STORM) dye chemistry described herein to these intracellular structures for the purpose of facilitating downstream isolation or analysis.

As described herein, the patterns may have super-resolution dimensions (i.e., dimensions that are less than the resolution limit of an optical detection system). For example, the patterns may have features or components with dimensions that are less than the diffraction limited resolution (and are thus located within a diffraction limited area, which may be for example a few hundred nanometers in one dimension).

Thus, in one aspect, provided herein is a method comprising

(i) irradiating, in the presence of a primary thiol containing photoswitching agent, a plurality of fluorescent-competent molecules (dyes) each having a polymethine bridge and an intact pi (π)-conjugated system disposed, and optionally dispersed, on a substrate having a first area and a second area, at or near the absorbance/excitation wavelength of the dye molecules, and until no fluorescence is detected from the plurality of fluorescent-competent molecules (dyes),

(ii) irradiating the plurality of fluorescent-competent molecules (dyes) at a wavelength and energy density sufficient to dissociate the primary thiol containing photoswitching agent from on average a single fluorescent-competent molecule (dye) within a diffraction limited area, thereby generating a fluorescent signal from the dissociated fluorescent-competent molecule (dye),

(iii) detecting fluorescent signal from a single dissociated fluorescent-competent molecule (dye) and thereby determining the location of the single dissociated fluorescent-competent molecule (dye) on the substrate,

(iv) irradiating, at high power density, the substrate if the single dissociated fluorescent-competent molecule (dye) is located in a second area but not if the single dissociated fluorescent-competent molecule (dye) is located in the first area, and

(v) optionally repeating steps (i) through (iv).

In still another aspect, provided herein is a method comprising

(i) incubating a plurality of fluorescent-competent molecules (dyes) each having a polymethine bridge and an intact pi (π)-conjugated system disposed, and optionally dispersed, on a substrate having a first area and a second area, with TCEP (i.e., (tris(2-carboxyethyl)phosphine)) or the other phosphine-based photoswitching/reducing agent for a sufficient time for the phosphine-based photoswitching/reducing agent to bind to the dyes and optionally until no further fluorescence is observed (as the incubation may be carried out with or without irradiation),

(ii) irradiating the plurality of fluorescent-competent molecules (dyes) at a wavelength and energy density sufficient to dissociate TCEP (i.e., (tris(2-carboxyethyl)phosphine)) or the other phosphine-based photoswitching/reducing agent from on average a single fluorescent-competent molecule (dye) within a diffraction limited area, thereby generating a fluorescent signal from the dissociated fluorescent-competent molecule (dye),

(iii) detecting fluorescent signal from a single dissociated fluorescent-competent molecule (dye) and thereby determining the location of the single dissociated fluorescent-competent molecule (dye) on the substrate,

(iv) irradiating the substrate, at high power density, if the single dissociated fluorescent-competent molecule (dye) is located in a second area but not if the single dissociated fluorescent-competent molecule (dye) is located in the first area, and

(v) optionally repeating steps (i) through (iv).

In some embodiments, when step (i) is performed with TCEP or other phosphine-based photoswitching/reducing agent, the incubation may be performed together with an irradiation step. Step (i) may be performed with and/or may be followed by an irradiation step for the purpose of determining whether all dyes have been bound to TCEP or other phosphine-based photoswitching/reducing agent (e.g., to determine that no further fluorescence is observed).

Irradiation may be performed using a single pulse of short duration such as a <200 femtosecond pulse. Typically, the irradiation takes the form of one or two or more of these ultrashort single pulses, provided the total irradiation time or duration at this step is long enough to activate (unquench) all of the dyes but not so long as to photobleach the dyes arbitrarily or in total. The duration may be shorter than the time it takes for the reconfigurations of electrons required for bond breakage that precedes photobleaching. Therefore, in some cases, the sum of the pulse durations should be less than 200 femtoseconds or less than the time needed for electron rearrangement to break the bond to the sulfur (in the case of a primary thiol) or the phosphorus (in the case of a phosphine-based photoswitching agent such as TCEP).

In some embodiments, the fluorescent-competent molecules (dyes) are similar cyanine-based dyes with five or more carbons in their polymethine bridges constituting at least part of the dye pi-conjugated system, and optionally including those with ring substituents for slight red- or blue-shifting of absorbance/emission. In some embodiments, the fluorescent-competent molecules (dyes) are Cy5, Cy5.5, Cy, or Alexa647.

In some embodiments, the primary thiol photoswitching agent is beta-mercaptoethanol, L-Cys-mercaptoethanol, or mercaptoethylamine (MEA).

In some embodiments, the phosphine-based photoswitching/reducing agent is TCEP (i.e., (tris(2-carboxyethyl)phosphine)) or another phosphine-based photoswitching agent.

Irradiating in step (i) may be carried out at the peak absorbance wavelength of the dye. Examples include at or near 650 nm for Alexa647 and at or near 649 nm for Cy5.

In some embodiments, the fluorescent-competent molecules (dyes) are Cy5 and irradiating in step (i) is carried out at or near 650 nm and irradiating in step (ii) is carried out at a wavelength in the range of about 300 to about 405 nm. In some embodiments, the fluorescent-competent molecules (dyes) are Cy5 in proximity to Cy3, and irradiating in step (i) is carried out at or near 650 nm and irradiating in step (ii) is carried out at or near 532 nm.

In some embodiments, fluorescence in step (i) and fluorescent signal in step (iii) is detected using a CCD or EMCCD camera or a CMOS-based detector.

In some embodiments, irradiating in step (iv) is performed using a passively or actively mode-locked laser system.

In some embodiments, irradiating in step (iv) is performed using power densities in the range of at or near 100 kW/cm² to at or near 1 MW/cm², or 100 kW/cm² to at or near 1 GW/cm² or 100 kW/cm² to at or near 1 TW/cm².

The duration of the irradiating in step (iv), as well as the duration of other irradiating steps, is shorter than the time required to photocleave (or photodissociate) the primary thiol adduct from quenched dyes. In some embodiments, irradiating in step (iv) is performed for a duration on the order of tens or low hundreds of femtoseconds. In some embodiments, irradiating in step (iv) is carried out for <200 femtoseconds, whether such step is performed with a single or multiple pulses.

In some embodiments, irradiating in step (i) is performed using a laser, optionally coupled to a DMD array. Specific examples of suitable instruments include those that achieve targeted laser exposure in the context of TIRF such as but not limited to Nikon “Photo activation illumination unit” and Andor Micropoint system. Generally, any system utilized for targeted photo-uncaging/photo-activation may be used in the methods of the present disclosure. In some embodiments, each grid of the DMD array performs a separate parallel STORM process. In some embodiments, irradiating in step (iv) is performed using a DMD array. An example of a DMD unit coupled to Nikon Ti scope is the Ti-LAPP. Another suitable system is the Andor MOSAIC/MOSAIC3 system.

In some embodiments, steps (i) through (iv) are repeated until no further fluorescent signal is detected in the second area.

In some embodiments, after steps (i) through (iv) are repeated until no further fluorescent signal is detected in the second area, the method further comprises

(vi) irradiating the substrate at a wavelength sufficient to dissociate the primary thiol containing photoswitching agent (or the phosphine-based photoswitching/reducing agent such as TCEP) from fluorescent-competent molecules (dyes) in the first area, and removing the dissociated primary thiol containing photoswitching agents (or the phosphine-based photoswitching/reducing agent such as TCEP).

In some embodiments, the method further comprises

(vii) irradiating, in the presence of a primary thiol containing intermediate or final agent, the substrate at the absorbance/excitation wavelength of the fluorescent-competent molecules (dyes).

In some embodiments, the primary thiol containing intermediate agent comprises a reactive group or binding domain.

In some embodiments, TCEP or other phosphine-based photoswitching/reducing agent comprises a reactive group or binding domain.

In some embodiments, the method further comprises contacting the substrate with an agent that reacts with the reactive group or an agent that binds to the binding domain.

In some embodiments, the substrate has a diffraction limited area. In some embodiments, the first area and/or the second area is a diffraction limited area.

In some embodiments, the method is performed at low temperature.

In some embodiments, the method is performed in a non-aqueous environment or buffer. In some embodiments, the method is performed in an organic buffer. In some embodiments, the method is performed in a vacuum. In some embodiments, the method is performed in or on a polymer matrix or a transparent solid that is penetrable by light of the appropriate wavelength, wherein the dyes are accessed by diffusion, facilitated or not, of the agent to be patterned. In some instances, a three-dimensional structural support may be covered with dyes, and a negative selection can be performed under vacuum or under a first set of conditions (including solvent and temperature conditions), and the final patterning step may be performed under a second set of conditions that may be different from the first set. In some embodiments, negative selection may be performed under vacuum and the final patterning step may be performed under in an aqueous or inorganic solvent. This may be appropriate where the negative patterning conditions are incompatible with the agent to be patterned. Ultimately, the nature and stability profile of the agent to be patterned will dictate the conditions to be used in the final patterning step, and those conditions need not be identical to those used for negative selection. Alternatively, negative selection and the final patterning step may be performed under the same conditions.

These and other aspects and embodiments of the invention will be described herein and are considered to be part of this disclosure.

### BRIEF DESCRIPTION OF DRAWINGS

FIG. 1A provides an overview of in this disclosure.

FIG. 1B illustrates various aspects and embodiments involving STORM-based negative patterning.

FIG. 2 provides various mechanisms underlying STORM-based negative patterning.

FIG. 3 shows an illustrative implementation of a computer system 600 that may be used in connection with any of the embodiments of the invention described herein.

### DETAILED DESCRIPTION OF INVENTION

Super-resolution imaging methods are known in the art and include but are not limited to Stochastic Optical Reconstruction Microscopy (STORM) (ref. 1). Various aspects of this disclosure transform super-resolution imaging methods, such as STORM, into high-throughput tools that allow for patterning of molecules at the same resolution at which they can be optically resolved. Thus, certain methods disclosed herein employ STORM techniques and build upon them to pattern a substrate at a super-resolution level. The ability to pattern a substrate at super-resolution dimensions has various applications including lithography. Moreover, the invention facilitates patterning of various cargos also thereby broadening the utility of the method beyond lithography and into the realm of biological assay and synthetic biology.

Images may be acquired continuously (e.g., using time-lapse techniques) or serially (with for example subsequent alignment and overlaying), optionally with drift correction if the substrate (or stage) moves during image acquisition. Methods for drift correction are known in the art, including methods for automated or “on-the-fly” drift correction. These latter types of drift correction may be particularly suited to the methods of this disclosure where it may be undesirable to halt a process or cycle in order to measure and correct for drift. These methods would allow for drift correction while the process or cycles are being performed and would be able to achieve resolution patterning on the order of ˜10 nm. Alternatively, if lower level resolution patterning is sufficient, a manual drift correction can be performed (e.g., at regular intervals, such as but not limited to about every 15 minutes through to about every hour, or longer), depending on the severity of the drift. Examples of drift correction approaches include correlation-based drift correction and drift correction based on fiducial markers (including brightfield fiducial markers), both of which have been used STORM. See for example Vaughan et al. Nature Methods 9:1181-1184 (2012).

The resultant images can then be used to define probe binding and thus target location.

### Negative-Patterning Methods

Certain aspects and embodiments of the invention provide negative-patterning approaches in order to pattern or stencil a substrate or surface. These methods involve patterning via stochastic dye activation and decision-based high order photobleaching.

In a negative patterning approach, suitable dyes are those that can be photoswitched via reversible binding to an adduct like a primary thiol or via reaction with a phosphine-based reducing agent such as TCEP. Preferred dyes also have a sufficiently long polymethine bridge to allow for reversible primary thiol or TCEP binding. The particular reaction intermediates and pathways for these two classes of photoswitching agents may be different. For example, phosphine-based compounds do not require irradiation to catalyze adduct formation because they do not require that their dye targets be in a triplet state to react. Nevertheless, the end product is an adduct. (Vaughan et al. Phosphine-quenching of cyanine dyes as a versatile tool for fluorescence microscopy. J. Am. Chem. Soc. 135(4), pp. 1197-1200 (2013).) Exemplary dyes include Cy5, Cy5.5, Cy7, Alexa647 (ref. 33). Derivatives of these dyes having different substituent groups in the rings at the ends of the polymethine bridge, which may act to improve dye stability or to slightly red or blue-shift emissions, are also suitable. The dyes are typically able to form a conjugate thereby allowing an end user to attach chemical handles thereto, with intact pi-conjugated systems remaining after the negative patterning process.

In some instances, the primary thiol-based dye quenching mechanism (ref. 33) for STORM may be performed for example with cyanine dyes having (1) red absorbance wavelength of about 650 nm, (2) sufficiently long polymethine bridges, and (3) intact π-conjugated systems (ref 1, 33-35).

Other dyes that may be used include Alexa488 (maximum absorbance of about 491 nm), Alexa532 (maximum absorbance of about 532), and Alexa 568 (maximum absorbance of about 572).

In some embodiments, the dyes have a polymethine bridge of at least 5 carbons. The methods rely upon the ability of these dyes to cycle through activation/unquenching to localization to deactivation/quenching stages in STORM. Virtually any dye that is capable of forming a physical adduct (to mediate photoswitching) and is susceptible to a primary thiol attack or attack by a phosphine-based photoswitching/reducing agent such as TCEP and which assumes structurally distinct states in its quenched (OFF) and unquenched (ON) states (as described herein) can be used in the methods of this disclosure.

Dyes present in an area of interest are ultimately complexed (or bound) to arbitrary chemical groups (which may be handles for attaching desired cargo or may be the desired cargo itself). These arbitrary chemical groups comprise solvent-exposed primary thiols. In this manner, the dyes themselves may be regarded as “handles” to which these arbitrary chemical groups are complexed (or bound). Dyes outside the area of interest will be permanently photobleached (sometimes referred to herein as “destroyed”) and not bound to such chemical groups. Permanent photobleaching intends some bond cleavage or irreversible adduct addition as opposed to a temporary change such as reversible structural isomerization or reversible radical formation (such as the radical anion form of direct STORM dyes (ref 41) that can be reversed via intermolecular interactions with molecular oxygen, as an example).

Substrates or surfaces are thereby patterned based on the selective deposition of such chemical groups.

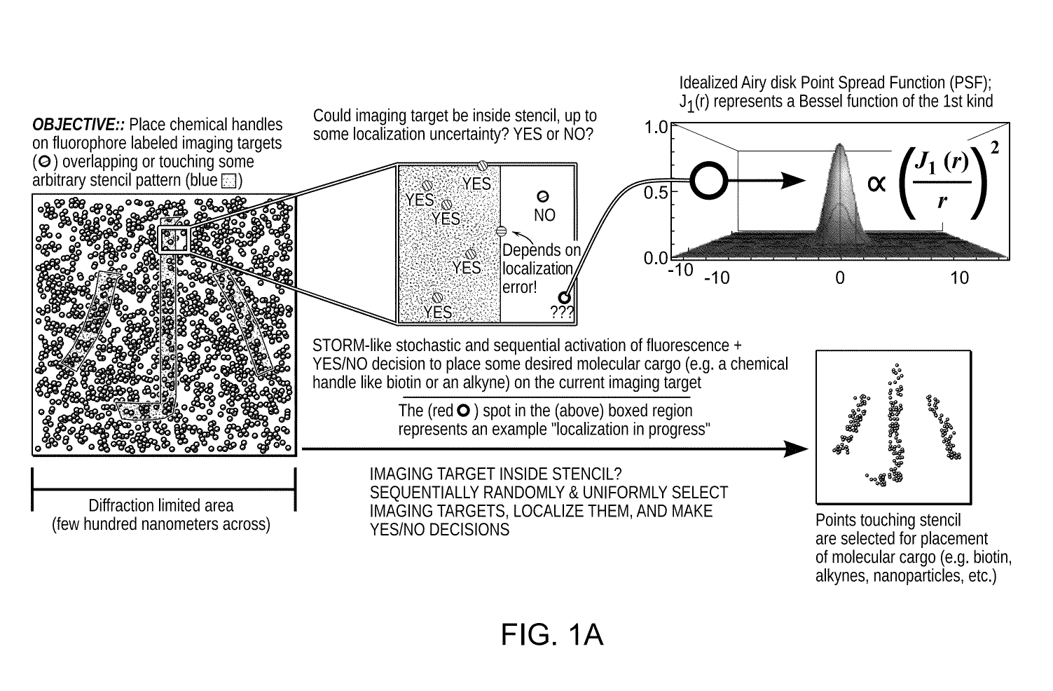

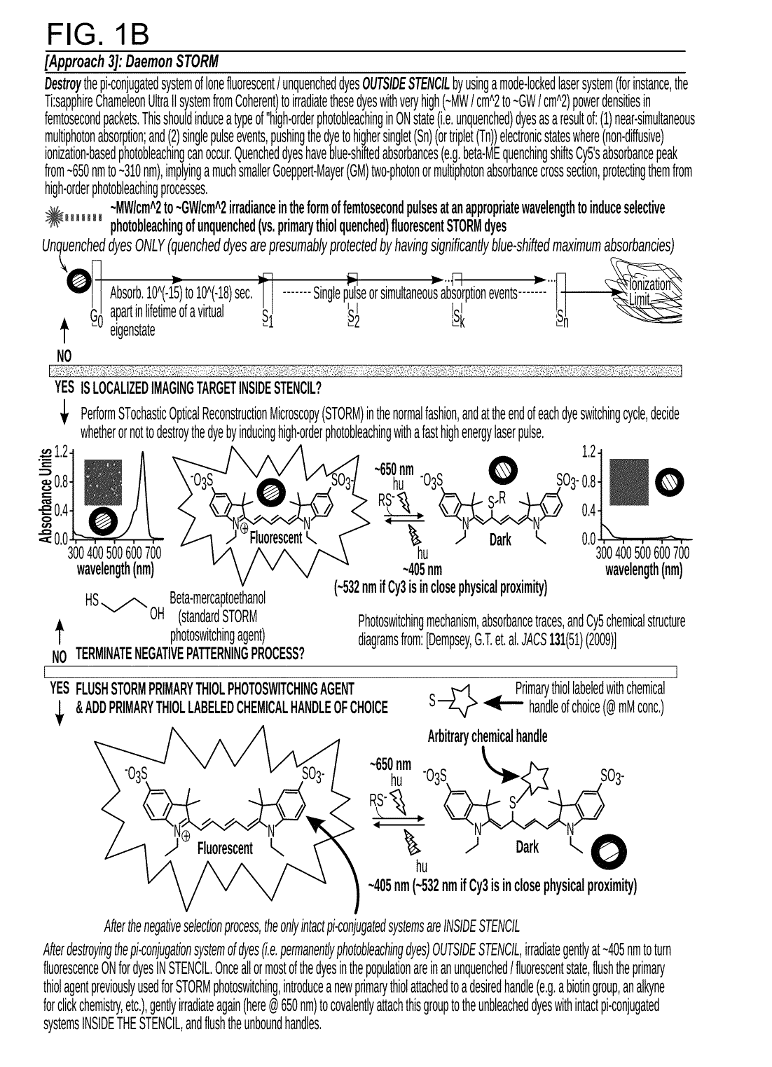

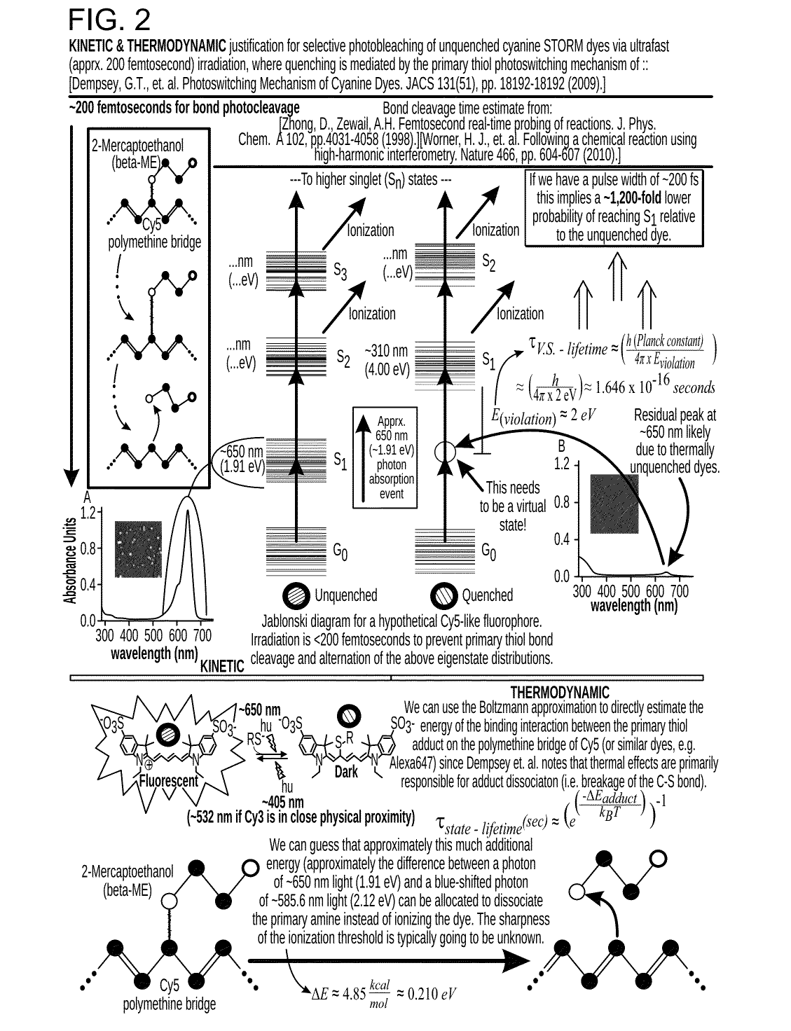

This disclosure takes advantage of and modifies the unquenched/ON to localized to quenched/OFF cycling of STORM dyes. As will be described in greater detail below and as illustrated in FIGS. 1B and 2, a STORM dye absorbs energy at its absorbance wavelength causing it to transition from its G₀ state to its S₁ singlet state. Dyes in the S₁ singlet state transition at a certain probability to a T₁ triplet state. The T₁ triplet state is vulnerable to primary thiol attack in the presence of a primary thiol containing photoswitching agent, an event that results in a quenched (or OFF) state of relatively long lifespan compared to other states in the STORM cycle. The OFF state refers to a state that is not fluorescent-competent. The quenched dyes are then irradiated at shorter wavelengths (e.g., at or below 405 nm) in order to cleave the bond between the dye and the photoswitching agent. This cleavage releases the photoswitching agent and results in a transition of the dye from the quenched (or OFF) state to an unquenched (or ON) state. The ON state minimally intends that the dye is fluorescent-competent (i.e., it is capable of absorbing additional energy and fluorescing). It is to be understood that the ON state may embrace a fluorescent state as well. This OFF to ON transition occurs using energy (or power density) levels that cause on average only one dye to transition. In this way, decisions can be made at the level of a single dye. Suitable energy densities range from for example 10-200 W/cm² or 10-100 W/cm² or 5-30 W/cm². The wavelength and energy density required for the OFF to ON transition depends on the particular dye and the existence of a juxtaposed dye. In the case where Cy5 is juxtaposed to Cy3, the activation power density can actually go down to ˜1 W/cm². It has been reported that a single Cy5 can be switched on the order of hundreds of cycles before it is permanently photobleached (ref. 1). In the case of Cy5, such cycling may involve irradiating the dye with a red laser (633 nm, 30 W/cm²) to excite fluorescence from Cy5 and to switch Cy5 to the dark state, and then irradiating with a green laser (532 nm, 1 W/cm²) to return Cy5 to the fluorescent state.

For the ON to OFF transition, irradiation intensities in the range of ˜5 W/cm²-100 W/cm² can be used (ref. 1). However, it is possible to use intensities on the order of hundreds of mW/cm² or up to tens of kW/cm². Since the probability that a dye enters a triplet state per single photon adsorption event is fixed, lower ON-to-OFF or imaging irradiation power densities allow for longer dye ON times, and conversely higher irradiation power densities allow for shorter dye ON times, and therefore regardless of the power density employed it is possible to output the same order of magnitude number of photons (e.g., 10⁴ to 10⁶).

Once the OFF to ON transition occurs, the dye in the ON state can be visualized (through capture of photons released by the dye as it fluoresces) and thus localized.

TCEP (tris(2-carboxyethyl)phosphine) can be used in place of a primary thiol such as beta-ME or for the final patterning step (described herein), with the exception that TCEP will react with dye molecules regardless of whether they are in the triplet or ground state. In other words, when TCEP is used, it is not necessary to irradiate at the peak dye absorbance wavelength to turn one, more, or all of the dyes to the OFF state. Instead the end user need only wait for a sufficient period of time to observe the transition.

The methods further include a post-localization decision step to either (a) destroy, via high order photobleaching processes (ref. 36-40), the π-conjugated system of the single unquenched (or ON state) STORM dye or (b) preserve the single unquenched STORM dye. The decision of whether to destroy or preserve depends on the location of the single unquenched STORM dye within each diffraction limited area under observation (or of interest). During this decision step, the collected localization data are used to determine whether to: (a) simply cycle the unquenched (or ON state) dye back to a transient quenched (or OFF state) (e.g., if the dye has a sufficient probability of being located inside a lithographic stencil or region of interest) or (b) specifically and permanently (i.e., irreversibly) photobleach the unquenched dye, while leaving unperturbed quenched (or OFF state) dyes. As described below, the selective nature of the irreversible photobleaching is achieved at least in part due to the distinct blue-shifted absorbance maxima of the quenched (or OFF) state dyes which renders the quenched dyes less likely to absorb the red wavelength used to photobleach. This decision step may be referred to herein as a “burn or bypass” step.

It will be apparent in the context of this disclosure that the decision step is only reached (and/or the photobleach step is only performed), in most instances, when only one unquenched (or ON) state dye is detected on the substrate or the surface undergoing STORM processing. In this manner, the decision is effectively made at the level of single dyes and at super-resolution dimensions. If two spots of fluorescence are detected, then the decision step is itself bypassed and the STORM cycle is repeated (e.g., the fluorescence-competent dyes are transitioned to their triplet states, reacted with the photoswitching agent, and thus rendered in an OFF state having a longer lifetime, followed by irradiation to induce the ON state again, photon detection and localization, etc.).

It will also be apparent in the context of this disclosure that the substrate or surface typically has an area greater than the diffraction limited region or area. The method allows an end user to deposit or pattern the substrate or surface at dimensions that are below the diffraction limited region (or area or limit).

It is to be understood that the photoswitching process used in STORM and the negative patterning methods of this disclosure is a transient reversible process and that cycling through quenched and unquenched dyes is expected to occur repeatedly. In contrast, the photobleaching process used in the negative patterning methods of this disclosure is irreversible and permanent. Once a dye is photobleached, it is no longer competent to assume an ON or OFF state.

The following provides a more detailed description of the negative patterning methods of this disclosure.

This disclosure contemplates that specific (or selective) photobleaching of unquenched (or ON state) dyes (versus quenched (or OFF state) dyes) can be achieved with femtosecond irradiation at high power densities (e.g., about 100 kW/cm² to at or about 1 MW/cm², or about 100 kW/cm² to at or about 1 GW/cm², or about 100 kW/cm² to at or about 1 TW/cm²). The method intends, in some instances, to direct a single <200 femtosecond pulse at the population of dye molecules to insure that the initial pulse does not dissociate the primary thiol adduct from other dyes, which are then photobleached by successive pulses in a train. Alternatively, a small number of pulses (e.g., 2, 3, etc.) can be used provided the total irradiation duration of these pulses when combined is less than 200 femtoseconds. In addition, the method covers instances in which jumps are made through virtual states and sparse eigenstates (or oddly spaced eigenstates) to photobleach an unquenched dye. Passing through virtual states requires power densities on the range of TW/cm² and in some instances GW/cm², because they only last for hundreds of attoseconds to a few femtoseconds and another photon absorption event is needed in this time interval to prevent the fluorophore from decaying to a lower singlet state or the ground state.

Photobleaching may be accomplished for example via femtosecond irradiation-induced multiphoton ionization (ref. 36-40) using a mode-locked femtosecond laser system which may be an actively or passively mode-locked system (e.g. Coherent's Ti:sapphire Chameleon Ultra II system) (ref. 36).

Irradiation intended to permanently photobleach, according to the methods provided herein, may be carried out with any device, system or instrument, including any of those recited herein including for example a digital micromirror device (DMD) array. Using the negative patterning methods provided herein it is possible to continually cycle dyes until each diffraction limited area where STORM is being carried out via a DMD mirror has an active or unquenched dye outside the stencil. When that point is reached, STORM is no longer performed globally and instead the entire surface is irradiated in one or a series of femtosecond pulses. These pulses should be non-overlapping to avoid indiscriminately photobleaching dyes.

The pulses used to photobleach may be ultrashort (or ultrafast) (e.g., <200 femtoseconds). Moreover, typically a single pulse (e.g., a single <200 femtosecond pulse) is directed at the population of dye molecules. This can be done using for example electro-optical shutters. This insures that a first pulse does not impact (e.g., dissociate) the primary thiol adduct from other dyes, which are then photobleached by successive pulses in a train. A pulse duration, including a sum total pulse duration, of about less than 200 femtoseconds is less than the time it takes to break bonds and re-allocate electrons, thus, changing the distribution and clustering of eigenstates which allows the selective photobleaching of dyes, such as cyanine dyes, with primary thiol adducts along their polymethine bridges by disrupting their pi-conjugated systems. This in turn significantly increases the HOMO to LUMO gap, and a ˜310 to ˜405 nm light would be needed to dissociate the adduct from quenched dyes.

As discussed above, quenching of a STORM dye with a primary thiol containing agent significantly blue-shifts the absorbance peak of a dye. As an example, beta-mercaptoethanol (beta-ME) binding to (and thus quenching of) Cy5 shifts the absorbance peak of Cy5 from ˜650 nm to ˜310 nm) (ref 33). The quenched dye is expected to have a much smaller Goeppert-Mayer (GM, units: 10⁻⁵⁰ cm⁴ s molecule⁻¹ photon⁻¹) two-photon or multi-photon absorbance cross section at the red or near-infrared wavelengths used to permanently photobleach fluorescent unquenched (or ON state) dyes. Thus, high order photobleaching via multiphoton absorption should be exponentially less likely for quenched (or OFF state) dyes, and in this way photobleaching occurs selectively with unquenched (or ON state) dyes.

Red to infrared irradiation is used for both typical STORM dye quenching (as described herein) and for high order photobleaching. The irradiation time scales and energies of these two processes are significantly different. STORM reversible dye quenching is likely mediated by the induction of a long-lived reactive T₁ triplet state from the S₁ singlet state. The T₁ triplet state is vulnerable to primary thiol attack (ref 33). The T₁ triplet state is less reactive and has a lower energy than the singlet S₁ state, and it has a duration of micro- to milli-seconds which is many orders of magnitude (including for example 6 or more orders of magnitude) longer than the lifetime of the S₁ state, which is typically measured in nano-seconds (ref. 41). In contrast, in femtosecond irradiation-based high order photobleaching, a dye is typically promoted through a succession of Sₙ singlet states to the ionization limit via single and/or multiple simultaneous absorption events (ref. 36-40). Photobleaching is independent of the dye triplet state population and micro- to milli-second diffusion processes (e.g., for dissolved molecular oxygen or freely diffusing reactive dyes) (ref. 37, 42). Photobleaching can be achieved using a femtosecond laser system having power densities in the range of about 100 kW/cm² to about 1MW/cm² or higher including on the order of 1 GW/cm² or even 1 TW/cm², for the reasons and instances specified herein.

The method contemplates that dyes located outside of a lithographic stencil (or region of interest) are subjected to high order photobleaching at an energy that is below the energy range that causes general ablation of the entire substrate or surface) (ref. 36, 43). The end result of this process is that most or all of the remaining intact dye π-conjugated systems will be located inside the stencil (or region of interest). Once reaching this end-stage, the method again employs reversible STORM photoswitching in order to load the intact dyes with an arbitrary chemical group of interest by swapping the primary thiol containing photoswitching agent with a primary thiol containing arbitrary chemical group. As will be understood the disclosure contemplates use of chemical groups having primary thiols whether those primary thiols are naturally part of that chemical group or are a modification added to the chemical group (e.g., the chemical group may be a desired cargo that is modified to contain a primary thiol).

More specifically, the following steps are contemplated at this end-stage: (1) dissociating the photoswitching agent from all the dyes inside the stencil via irradiation with about 405 nm (e.g., between about 260 nm to about 405 nm, or about 300 nm to about 405 nm) light, (2) removing the buffer to remove the released photoswitching agent, (3) flowing in arbitrary chemical groups of choice comprising a primary thiol or a phosphine-based photoswitching/reducing agent such as TCEP, and finally (4) performing the standard dye quenching procedure again to covalently attach the arbitrary chemical groups of choice to the intact π-conjugated systems of dyes in the stencil. It will be understood that this last step may involve irradiating the dyes with light at their absorbance wavelength in order to transition the dyes back to a T₁ triplet state that is susceptible to primary thiol attack. It will be further understood that this last step may involve incubation with a cargo-comprising phosphine-based photoswitching/reducing agent, without the need to undergo further irradiation.

The photoswitching, photobleaching and ultimately swapping of the photoswitching agent for an arbitrary chemical group are facilitated in part by the long-lived metastable covalent bond between the cyanine dye's π-conjugated system and the primary thiol of the photoswitching agent.

Suitable photoswitching agents includes but are not limited to b-mercaptoethanol (BME, beta-ME), L-cysteine methyl ester (L-Cys-ME), and mercaptoethylamine (MEA).

The following provides more detail relating to STORM dye photoswitching.

Using STORM, it is possible to stochastically switch on single STORM photoswitchable dyes. Examples of such dyes include Cy5, Cy5.5, Cy7, and Alexa647 (ref 1, 33-35). On average, it is possible to switch on one such dye per diffraction limited area to the ON (i.e., unquenched or fluorescent or fluorescent-competent) state. This is accomplished using irradiation ranging from about 260 nm to about 405 nm (including about 300 nm to about 405 nm, and at about 405 nm) when single dyes are used. Irradiation at about the absorbance wavelength of the particular dye being used (such absorbance wavelengths being known in the art) is used to transition ON state dyes to the OFF (i.e., quenched or non-fluorescent) state. In terms of the ON state switching mechanism, lower wavelength irradiation (e.g., between about 300 nm to about 405 nm) can directly catalyze the dissociation of the photoswitching agent from the polymethine bridge π-conjugated system (ref 33) of the dye. Features of suitable dyes are provide herein. For example, a suitable dye minimally has a polymethine bridge that is susceptible to primary thiol attack or TCEP (i.e., (tris(2-carboxyethyl)phosphine)) attack. Red dyes having a 5 carbon polymethine bridge such as Cy5, Cy5.5, Cy7, etc. are examples of such dyes. Once the dye is in the ON state, it is able to rapidly cycle between a ground state, G₀, and an excited single state, Sᵢ, emitting a photon during the S₁ to G₀ transition (a process which typically occurs on the order of picoseconds (or tens of picoseconds) to nanoseconds) (ref. 41).

Alternatively, when dyes are used in a pair, such as a Cy5-Cy3 pair, then longer wavelengths may be used to transition from OFF to ON states. For example, when a Cy5-Cy3 pair is used, light of about 532 nm can be used to photoswitch the Cy5 dye. When dyes are used in pairs, as in this example, they should be located within collision distant from each other (e.g., within nm of each other). The irradiation may be brief (e.g., irradiation of about 5 W/cm² with about 532 nm laser light (ref. 33, 44-46)).

For switching dyes back to the OFF state, irradiation at about the absorbance wavelength of such dyes catalyzes (e.g., via the induction of a long-lived reactive triplet state with microsecond to up to millisecond lifetimes) (ref. 41), the formation of a metastable bond between the primary thiol containing photoswitching agent and the dye π-conjugated system (ref. 33). This means that red STORM dyes will turn OFF at a certain rate as they are imaged at the wavelength corresponding to their highest quantum efficiency.

The stability of the metastable covalent bond between the photoswitching agent and the dye may be expressed in terms of the lifetime of the bond. In the case of Cy5 and beta-ME (or BME) as the switching agent, the lifetime of the metastable bond is governed by a single exponential with rate parameter λ_{adduct} of about 0.017 min⁻¹, implying a τ=(λ_{addict})⁻¹ of about 59 minutes or about 1 hour mean lifetime for the covalent adduct under these conditions (ref 33). It has been previously reported that λ_{adduct} is significantly decreased at lower temperatures, implying that thermoswitching is primarily responsible for the reversal of covalent adduct formation (ref. 33).

Multiphoton ionization, such as that contemplated for high order photobleaching, can result from a combination of: (1) ‘simultaneous’ photon absorption events, where ‘simultaneous’ means that two or more photons strike within the optical cross-section of a dye within the lifetime of a virtual eigenstate (about 10⁻¹⁵ second to about 10⁻¹⁸ second) (i.e., a low probability non-energy conserving state where a photon is absorbed without a corresponding observable state change in the molecule) (ref. 36-40); or (2) sequential single photon absorption induced transitions (ref 36-40) (such as jumping from eigenstate to eigenstate including S1→S2 or S2→S3, etc.). These states do not violate conservation of energy like the aforementioned virtual state in (1) and, thus the dye can reside in these states for orders of magnitude longer prior to falling back down to GO by way of one or more radiative and/or non-radiative transitions. By “orders of magnitude longer”, about 3 to 6 orders of magnitude are intended. Hither order singlet states for some dyes have picosecond lifetimes, and some virtual states can typically only exist for 10⁻¹⁵ to 10⁻¹⁸ seconds.

Through a combination of these mechanisms, high energy density femtosecond pulses can push a dye through successive singlet excitation states to the ionization limit (e.g., about 5.5 eV for the Hoechst 33342 fluorophore) (ref 47), thereby inducing the formation of an electron-cation pair that can separate in a polar environment, e.g., water (ref. 48) or solvents like ethanol. The virtual eigenstate for mechanism (1) is a simple consequence of Heisenberg's energy-time uncertainty principle allowing for energy non-conserving processes conditioned on these processes existing for a time less than

$${τ}_{v} \approx \frac{h}{4 π ( {E}_{violation} )}$$

where h is the Planck constant and Eᵥᵢₒₗₐₜᵢₒₙ is the difference in energy between the virtual state and the nearest real eigenstate (typically on the order a few eV or less for most organic chromophores).

In the case of Green Fluorescent Protein (GFP), where S₁ is 2.6 eV above G₀ (ref. 49), the allowed lifetime of an intermediate that is about 1.3 eV virtual state can be approximated as τ_{v(GFP,S1)}≈2.5*10⁻¹⁶ seconds, which easily falls in the ≈10⁻¹⁵ to ≈10⁻¹⁸ second time-window for two-photon absorption. Although approximate, this calculation indicates that two near-infrared (e.g., about 954 nm) photons would have to strike GFP within about this time window to promote its transition to S₁ , its first excited state. This is a reasonable approximation (ref. 36).

Non-specific molecular ablation (ref 36, 43) occurs when a large number of near-simultaneous photons strike a molecule, thereby pumping the energy of a molecule, with sparse high level real eigenstates, to the ionization limit via a succession of virtual states. This is a consequence of mostly mechanism (1) (ref. 36). As an example, GFP has few high level singlet eigenstates above S₁ (ref. 49) Its primary photobleaching pathway during femtosecond irradiation is an “ablation-like” mechanism whereby a tryptophan residue about 14 Å from the GFP chromophore (ref 50) is ionized at an energy of about 4.5 eV (ref. 51) (via the simultaneous absorption of multiple photons), resulting in the release of plasma that attacks the chromophore (ref. 52).

Non-specific ablation generally occurs at energies about 20% higher than those required to induce high order photobleaching of most dyes (ref 36, 43), and therefore it should be possible to avoid such ablation when performing the methods provided herein. The lower energy required to photobleach may be due to the larger and more energetically favorable population of intermediate singlet excitation states below the ionization limit in dyes.

The method may be performed in the presence a sufficient concentration of scavengers for Reactive Oxygen Species (ROS) (e.g., the hydroxyl radical .OH) generated by multiphoton ionization and dissociation of water molecules (ref 53-55)). Examples include but are not limited to Trolox, cyclooctatetraene (COT), n-propyl gallate, 1,4-diazabicyclo[2.2.2]octane (DABCO), etc. Alternatively, the method may be carried out in a non-aqueous buffer (e.g., an organic buffer) in order to avoid ROS deriving from water molecules.

Still other agents may be present in the buffer including agents that help reduce a dye to the singlet ground state (GO) from a triplet state, in order to render the dye dark and more reactive. It is in this stage that singlet oxygen and other agents can access and permanently bleach a dye in a concentration-dependent manner.

It is possible that when a large number of dyes are present in a diffraction limited area, dyes located within a stencil (dyes that will be preserved) have to undergo an increased number of STORM cycles (i.e., activation/unquenching to localization to deactivation/quenching cycles) during the negative patterning process. During each cycle, there is a constant probability of permanent photobleaching of these dyes. In order to address this issue, and under the assumption that dyes in the quenched (OFF) state are protected from high order photobleaching processes for the reasons provided herein, the number of times needed to photoswitch dyes inside the stencil, as a consequence of STORM random subset activation, is both small and independent of the total count for dyes inside the stencil. Assuming uniform and random dye activation events, and letting m and n represent the number of dyes inside and outside the stencil, respectively, the exact expectation for the number of switching events each of the m dyes inside the stencil will have to undergo is only: E(x)=Hₙ≈γ+ln(n) (where γ≈0.5772156649 . . . is the Euler—Mascheroni constant), implying that the expectation grows about as fast as the natural logarithm of n. Thus, even in the extreme case of having a single dye inside a stencil and ≈10⁶ dyes outside of the stencil, the dye inside the stencil is only expected to photoswitch about H₍₁₀⁶₎≈14.393 times (or (Hₙ/P_{b}) where P_{b} is the efficiency for higher order photobleaching). Many STORM dyes can be switched hundreds of times prior to permanent photobleaching (ref 34, 44, 45, 56, 57), and this validates and supports the negative patterning approach.

The negative patterning approach described in this disclosure is suitable in commercial manufacturing applications for a number of reasons: (1) a real-time feedback and response system is not required, implying that the computational burden of massively parallel patterning with a Digital Micromirror Device (DMD) on a large field-of-view is significantly attenuated; (2) the ≈100 Hz to ≈1 kHz dye switching and localization speeds possible with STORM-based methods (ref. 35), where the individual dye localization precision is ≈17 nm along the xy axes and ≈45 nm along the z-axis, is ≈1-2 orders of magnitude faster than PAINT-based methods due to background fluorescence constraints (ref. 2, 3); (3) the false-positive rate for chemical handle patterning strictly decreases with patterning time; and (4) polar and/or organic buffers (including non-aqueous buffers) and/or lower temperatures can be used in these methods provided that the photoswitching agents are soluble (e.g., at millimolar concentrations). A sufficiently polar buffer is one that allows for anion-cation separation. Temperatures above the buffer freezing point can be used.

With respect to point (4) above, consider that lower temperatures imply lower stochastic thermoswitching of STORM dyes (ref 33), and thus fewer instances of the kind of “false-positive” events such as those that may arise if: (a) thermal effects cause a dye inside a stencil to stochastically become unquenched and turn ON in the same diffraction limited area as an unquenched STORM dye outside the stencil; (b) the thermoswitched dye inside the stencil fails to emit enough photons to allow for its detection amidst the background of the fluorescent dye outside the stencil; and (c) a dye inside the stencil is inadvertently destroyed by inducing high order photobleaching in the diffraction limited area surrounding the intended target dye. To reduce or eliminate these types of false-positive events, provided one can covalently juxtapose the photoswitching agent and the dye being switched, then one can presumably have the freedom to use temperatures ranging from above the freezing point for the polar solvent of choice (e.g., ≈−114° C. for Ethanol), making stochastic STORM dye thermoswitching (as in (a) above) completely negligible.

The ability to use a wider variety of polar buffers may also allow the use of a wider variety of STORM dyes, possibly with higher quantum efficiencies and brightnesses. The buffer must be sufficiently polar to insure anion-cation separation during the process of multiphoton ionization (re. 48). It is reasonably expected that a dye in a highly-reactive ionized state should be able to self-quench via an intramolecular pathway. If such intramolecular anion-cation splitting pathways exist, then negative patterning methods may be performed in buffers with diminished to negligible dipole moments (e.g., benzene or hexane). Alternatively, negative patterning methods could be carried out in the context of nitrogen containing atmospheres or under vacuum conditions, provided the STORM dye is covalently juxtaposed with a photoswitching agent.

In some instances, bright dyes or fluorophores are preferably used. As used herein, a “bright fluorophore” is one that emits a sufficient number of photons such that the CCD or EMCCD camera is able to detect a single dye. Dyes with low quantum efficiencies (i.e., the ratio of photons outputted relative to the number of photons inputted) may also be used in the methods described herein, and their low quantum efficiency may be compensated by increasing the power of the irradiation source. Of greater importance is the sheer brightness of the dye (i.e., its ability to output a sufficient number of photons to be detected by the contemplated devices).

Dye localization precision and thus the precision at which patterning can occur depends directly on the number of photons a dye can emit per STORM switching cycle. This is limited primarily by: (a) thermoswitching-based activation of another dye in the same diffraction limited area as the dye being localized (ref 33), i.e., the afore-mentioned “false positive” events during the negative patterning process; (b) the induction of a low energy chemically reactive T₁ non-fluorescent or “dark” triplet state with a micro- to millisecond lifetime (ref 41), an event which happens with some probability for every G₀ to S₁ to G₀ excitation and photon emission cycle and that can result in either permanent photobleaching (ref. 58) or reversible STORM photoswitching agent quenching (ref. 33). Whether (a) or (b) is rate limiting depends on the circumstances.

Greater freedom to use low temperatures, as elaborated for point (4) above, means the ability to push on constraint (a) to increase the length of each STORM cycle. While it is possible to generally push on time between reversible dye quenching events (ref 33) cited in constraint (b) by simultaneously dropping the concentration of STORM photoswitching agents (ref. 33) and employing triplet state depopulation techniques involving the use of special quenchers (ref 42, 59, 60) and/or an additional red-shifted laser line to induce Reverse Intersystem Crossing (ReISC) (ref 61-66), greater solvent freedom means longer ultimate dye lifetimes prior to permanent photobleaching. To briefly describe RISC, here a T₁ triplet state is promoted to a higher energy Tₖ triplet state (which is more chemically reactive and faster to photobleach) via absorption of a low energy near-infrared photon (ref 61-65). The idea is that the Tₖ triplet state will often have a smaller energy gap with the nearest fast-decaying Sᵢ singlet state, allowing for a Tₖ to Sᵢ reverse intersystem crossing event that has a much higher probability than a T₁ to S₁ event (ref 61-65).

FIG. 2 is an explanatory diagram intended to illustrate that <200 femtosecond packets of irradiation (of appropriately tuned intensity) can be used to selectively inactivate unquenched (vs. quenched) STORM dyes like Cy5. Kinetically and thermodynamically, dyes quenched in the standard way for STORM via conjugation with a primary thiol should have protection from permanent photobleaching during the <200 femtosecond irradiation event. Based on previous reports (Zhong et al., Femtosecond real-time probing of reactions. J. Phys. Chem. A 102, pp. 4031-4058 (1998) and Worner et. al. Following a chemical reaction using high-harmonic interferometry. Nature 466, pp. 604-607 (2010)), it is known that it takes about ˜200 femtoseconds to break a bond via irradiation-based methods (as opposed to mechanical force for example) and to reallocate the bonding electrons to the atoms on the opposite ends of the bond. If the irradiation pulse is kept on the order to femtoseconds (and more specifically to <200 femtoseconds), there is insufficient time for the quenched dyes to become unquenched and change their electronic configuration, and this protects such quenched dyes from permanent photobleaching. Unquenched dyes, however, are not preserved in this same manner. The disclosure contemplates that the irradiation pulse may be longer than the <200 femtoseconds with the proviso that if it is extended significantly then this increases the probability that the quenched dyes will receive enough energy to become unquenched. It is to be understood that more than one pulse may be used and the teaching provided above applies to the sum total duration of the multiple pulses (i.e., the sum total duration of the multiple pulses may be kept to less than 200 femtoseconds or if longer than 200 femtoseconds then there is an increased probability that quenched dyes may become unquenched).

From a kinetic perspective, the first excited state of the quenched dyes has roughly double the energy gap to the ground state as the unquenched dyes. This is illustrated for example by the lack of a peak at ˜650 nm for the quenched dye and the shift of this peak to ˜300 nm, meaning that a photon with ˜4.00 eV needs to be absorbed instead of one with an energy of ˜1.91 eV. In order to transition a quenched dye to the ionization limit with “red” ˜650 nm radiation, it is necessary to go through at least one additional virtual state relative to the same process for the unquenched dye. As calculated in FIG. 2, this corresponds to about a 1200-fold decrease in the probability of even getting to the first excited electronic state, which in turn means about a 1200 fold higher selectivity for bleaching unquenched dyes if the intensity/wavelength/duration for the femtosecond pulse can be appropriately tuned. It is to be understood that the Figure depicts numerical values appropriate for Cy5, but that the general schematic of the Figure applies equally to other dyes.

From a thermodynamic perspective, dissociation of the primary thiol adduct is primarily a thermal process (ref 33). Therefore, the use of the Boltzmann approximation to calculate the energy barrier for bond cleavage is justified. In the Figure, the number ˜0.21 eV is arrived at using the provided calculation details.

When TCEP (tris(2-carboxyethyl)phosphine) is used, it reacts spontaneously with the same dyes that can conjugate to the usual STORM primary thiol photoswitching agents. (Vaughan, J. C., Dempsey, G. T., Sun, E., Zhuang, X. Phosphine-quenching of cyanine dyes as a versatile tool for fluorescence microscopy. J. Am. Chem. Soc. 135(4), pp. 1197-1200 (2013).)

### Illustrative Embodiments

FIG. 1B illustrates various steps of the negative patterning approach described herein. Initially, a plurality of STORM dyes is provided on a substrate or surface that is being patterned. The STORM dyes are typically red dyes having a polymethine bridge and an intact pi (π)-conjugated system. Cy5 is used in FIG. 1B and is representative of this class of dyes that includes at least Cy5.5, Cy7 and Alexa647. The dye may be anchored to the surface. The substrate or surface has an area that is comprised of at least a first area and a second area. The first area is the area within which chemical or molecular or other moieties (other than the dyes) will be deposited. It may be referred to herein as the area or region of interest. The second area is the area within which chemical or molecular or other entities will not be deposited. The first area may be referred to as “inside the stencil” and the second area may be referred to as “outside the stencil” in this disclosure. The negative patterning approach aims to selectively deposit chemical or molecular or other moieties (other than the dyes used in the process) within the first area, thereby patterning the substrate or surface as desired by an end user. As will be appreciated by one of ordinary skill in the art, the moiety to be ultimately deposited on the substrate or surface may be virtually any moiety provided it either comprises a primary thiol or it binds to an intermediate moiety that is bound to the dye directly or indirectly.

The plurality of dyes is irradiated at their characteristic maximum absorbance/excitation wavelength. Such wavelengths are known for various of the STORM dyes to be used in this approach. For example, Cy5 has a maximum absorbance/excitation wavelength of about 649 nm, and Alexa647 has a maximum absorbance/excitation wavelength of about 650 nm. Alexa647 represents the brightest (or highest) photon yield STORM dye known (ref. 34 and ref. 35, Table 1). Typically the dyes within the plurality will be identical to each other. As has been described for STORM, the irradiation at this absorbance wavelength converts the dye from its ground G₀ to its excited S₁ state. Some dyes then revert to the G₀ state while some fraction of dyes transition to a T₁ triplet state having lower energy and less reactivity than the S₁ state. The lifetime of the S₁ state is on the order of picoseconds (or tens of picoseconds) to nanoseconds while the lifetime of the T₁ state is on the order of micro- to milli-seconds.

This first irradiation period is performed in the presence of a STORM photoswitching agent having a primary thiol. Such agents are referred to herein as primary thiol containing photoswitching agents or generally as photoswitching agents. Example of these agents are provided herein. The photoswitching agent attacks the dye through its primary thiol. The net result of the combined effect of irradiation at the absorbance wavelength in the presence of the photoswitching agent is that the dye is converted from a relatively short-lived fluorescent or fluorescent-competent (unquenched or ON) state to a relatively long-lived dark (quenched or OFF) state. For example, when the dye is Cy5 and the photoswitching agent is beta-ME, the dark (or OFF) state exists for about 1 hour. As should be understood, if not all the dyes enter the T₁ state in the first excitation cycle, then such dyes will cycle through one or more additional excitation cycles until all dyes are converted to the dark (or OFF) state. The lack of fluorescence on the substrate area or surface area is an indication that all the dyes have been converted to the dark (or OFF) state. It will be further appreciated that the photoswitching agent is present during the irradiation step in sufficient (i.e., non-limiting) amounts (or levels), including saturating or super-saturating amounts (or levels), so that all dyes in the plurality will be bound by the agent during this step.

It is to be understood in the context of this disclosure that the foregoing may be carried out using a phosphine-based photoswitching/reducing agent such as TCEP instead of a primary thiol containing photoswitching agent.

FIG. 1B illustrates the structure of Cy5 in the dark (quenched, fluorescent-incompetent, or OFF) state and the fluorescent or fluorescent-competent (unquenched or ON) state in the middle panel. The middle panel further shows the absorbance profile for each of these states. It is apparent that the unquenched (or ON) state is capable of absorbing light at about the 650 nm range while the quenched (or OFF) state lacks this ability and instead absorbs light of a much shorter wavelength (e.g., at about 300 nm). As discussed herein, the negative patterning approach exploits this difference is absorbance in order to selectively preserve dyes inside a stencil (the first area) and to destroy dyes outside a stencil (the second area). This selective preservation of dyes depending on their location on the substrate or surface translates into the ability to selective deposit chemical or molecular or other moieties of interest on the first area and not on the second area.

Once all the dyes are converted to the quenched (or OFF) state, then the substrate or surface is irradiated at a wavelength that triggers the dissociation of the photoswitching agent from the dark (or OFF) state dye. In the case of Cy5 and beta-ME, light in the range of about 260 nm to about 405 nm is sufficient to dissociate the dye from the photoswitching agent. Commercially available diode lasers that emit in this range including those that emit at or about 405 nm can be used. Once the photoswitching agent is dissociated from the dye, the dye transitions from the quenched (or OFF) state to a fluorescent or fluorescent-competent (or ON) state. As indicated in FIG. 1B, middle panel, this transition can also be accomplished using a longer wavelength (e.g., about 532 nm) if a Cy3 dye is in close proximity to the Cy5 dye.

The energy of light used to transition from the quenched to the unquenched states is set such that only limiting numbers and preferably single dyes on the substrate or surface transition from the OFF) state to the ON state. Once the dye has transitioned to the ON state, it will fluoresce thereby emitting photons. Thus, it is possible to visualize and thus localize single dyes on the substrate or surface, and thereby determine whether the dye is located inside a stencil (the first area) or outside a stencil (the second area). This visualization and localization can be carried out using for example CCD cameras or other similar type instruments. If the dye is located inside the stencil (the first area), then it is allowed to transition back to the OFF state, again through primary thiol attack of its T₁ state by the photoswitching agent. If instead the dye is located outside the stencil (the second area), then the substrate or surface is subjected to high order photobleaching (i.e., irradiation at high power density for ultrashort durations) to selectively photobleach that ON state dye. This irradiation occurs briefly, on the order of femtoseconds (e.g., less than 200 femtoseconds). The high power density irradiation may range from about 100 kW/cm² to about 1 MW/cm² or from about 100 kW/cm² to about 1 GW/cm² or from about 100 kW/cm² to about 1 TW/cm², and will be sufficient to destroy the pi (r) system of the dye, thereby precluding its ability to convert into the T₁ state and thus the OFF state. The energy level should not be so high however to non-specifically ablate a plurality of dyes on the substrate or surface, including dyes inside the stencil (the first area) as doing so will frustrate the selective process. Such photobleaching can be performed using a mode-locked laser system such as the Ti:sapphire Chameleon Ultra II system (commercially available from Coherent).

The dyes are cycled through the G₀ state to S₁/fluorescent/ON state to T₁/dark/OFF state in the presence of the photoswitching agent until no further fluorescent signals are observed outside the stencil (in the second area). At this point, the negative patterning process may be terminated and the dyes inside the stencil (the first area) may be modified as desired. This can be achieved by irradiating the substrate or surface with for example 405 nm light (or light of wavelength ranging from about 260 nm to about 405 nm) in order to dissociate the photoswitching agent from the dye, thereby converting the dye from an OFF state to an ON state. The photoswitching agent is then removed by for example removing and/or replacing the buffer over the substrate or surface. Once the photoswitching agent is removed, the substrate or surface is irradiated at the absorbance wavelength (e.g., for Cy5, about 649 nm) in the presence of a primary thiol arbitrary chemical agent. This latter primary thiol containing agent may be the final agent which an end user desires to deposit on the substrate or surface, or it may be an intermediate agent which provides a handle onto which the final agent binds. Examples of the latter intermediate agents include those having a biotin group, an alkyne group, and the like. The final agent may then be bound to the dye directly or indirectly. If indirectly, there may be one or more intermediate agents or moieties linking the dye to the final agent. The primary thiol containing agent is present at saturating or super-saturating levels. Similarly, the final agent may be provided in the context of a phosphine-based photoswitching/reducing agent or reactive group such as TCEP, and there also it may be present at saturating or super-saturating levels.

It will be appreciated that the negative patterning approach, like the other approaches provided herein, is suitable for patterning a substrate or surface or an area thereof (such as a first area, or an area inside a lithographic stencil) having dimensions on the order of a diffraction limited area.

In the lithographic context, the substrate or surface may be patterned with polymers or other lithographic agents such as but not limited to PMMA, PDMS, metals, nanowires, and the like.

### Patterning Agents, Generally

The substrates or surfaces of the above-described methods may be patterned with a variety of agents, including chemical and molecule agents. Below are examples of agents that may be patterned onto substrates or surfaces as described herein.

Examples of proteins for use in the methods of this disclosure include, without limitation, antibodies (e.g., monoclonal antibodies), antigen-binding antibody fragments (e.g., Fab fragments), receptors, peptides and peptide aptamers.

As used herein, “antibody” includes full-length antibodies and any antigen binding fragment (e.g., “antigen-binding portion”) or single chain thereof. The term “antibody” includes, without limitation, a glycoprotein comprising at least two heavy (H) chains and two light (L) chains inter-connected by disulfide bonds, or an antigen binding portion thereof. Antibodies may be polyclonal or monoclonal; xenogeneic, allogeneic, or syngeneic; or modified forms thereof (e.g., humanized, chimeric).

As used herein, “antigen-binding portion” of an antibody, refers to one or more fragments of an antibody that retain the ability to specifically bind to an antigen. The antigen-binding function of an antibody can be performed by fragments of a full-length antibody. Examples of binding fragments encompassed within the term “antigen-binding portion” of an antibody include (i) a Fab fragment, a monovalent fragment consisting of the VH, VL, CL and CH1 domains; (ii) a F(ab')2 fragment, a bivalent fragment comprising two Fab fragments linked by a disulfide bridge at the hinge region; (iii) a Fd fragment consisting of the VH and CH1 domains; (iv) a Fv fragment consisting of the VH and VL domains of a single arm of an antibody, (v) a dAb fragment (Ward et al., Nature 341:544 546, 1989), which consists of a VH domain; and (vi) an isolated complementarity determining region (CDR) or (vii) a combination of two or more isolated CDRs, which may optionally be joined by a synthetic linker. Furthermore, although the two domains of the Fv fragment, VH and VL, are coded for by separate genes, they can be joined, using recombinant methods, by a synthetic linker that enables them to be made as a single protein chain in which the VH and VL regions pair to form monovalent molecules (known as single chain Fv (scFv), as described in Bird et al. Science 242:423 426, 1988; and Huston et al. Proc. Natl. Acad. Sci. USA 85:5879-5883, 1988). Such single chain antibodies are also intended to be encompassed within the term “antigen-binding portion” of an antibody. These antibody fragments are obtained using conventional techniques known to those with skill in the art, and the fragments are screened for utility in the same manner as are intact antibodies.

As used herein, “receptors” refer to cellular-derived molecules (e.g., proteins) that bind to ligands such as, for example, peptides or small molecules (e.g., low molecular weight (<900 Daltons) organic or inorganic compounds).

As used herein, “peptide aptamer” refers to a molecule with a variable peptide sequence inserted into a constant scaffold protein (e.g., Baines IC, et al. Drug Discov. Today 11:334-341, 2006).

As used herein, “nucleic acid aptamer” refers to a small RNA or DNA molecules that can form secondary and tertiary structures capable of specifically binding proteins or other cellular targets (e.g., Ni X, et al. Curr Med Chem. 18(27): 4206-4214, 2011).

In certain embodiments, the fluorophore is one capable of being irreversibly or permanently photobleached.

### Exemplary Computer System

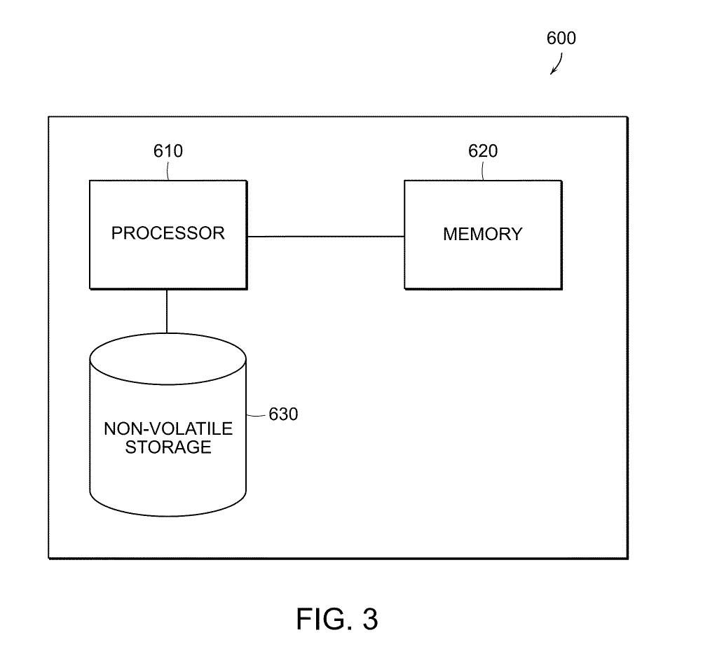

An illustrative implementation of a computer system 600 that may be used in connection with any of the embodiments of the invention described herein is shown in FIG. 3. The computer system 600 may include one or more processors 610 and one or more computer-readable non-transitory storage media (e.g., memory 620 and one or more non-volatile storage media 630). The processor 610 may control writing data to and reading data from the memory 620 and the non-volatile storage device 630 in any suitable manner, as the aspects of the present invention described herein are not limited in this respect. To perform any of the functionality described herein, the processor 610 may execute one or more instructions stored in one or more computer-readable storage media (e.g., the memory 620), which may serve as non-transitory computer-readable storage media storing instructions for execution by the processor 610.

In addition, one or more Graphics Processing Units (GPUs) can be used given their robust ability to perform highly repetitive and parallel tasks. Automated image analysis and drift correction during STORM microscopy can also make use of GPUs, as an example.

The above-described embodiments of the present invention can be implemented, in whole or in part, in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one non-transitory computer-readable storage medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

### Equivalents

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

“Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### REFERENCES

[1] Rust, M. J., Bates, M., Zhuang, X. Sub-diffraction-limit imaging by stochastic optical reconstruction microscopy (STORM) Nature Methods 3(10), pp. 793-795 (2006).
[2] Sharonov, A., Hochstrasser, R. M. Wide—field subdiffraction imaging by accumulated binding of diffusing probes. PNAS 103(50), pp. 18911-18916 (2006).
[3] Jungmann, R., Steinhauer, C., Scheible, M., Kuzyk, A., Tinnefeld, P., Simmel, F. C. Single—molecule kinetics and super—resolution microscopy by fluorescence imaging of transient binding on DNA origami. Nano Letters 10, pp 4756-4761 (2010).
[4] Yoshimura, Y., Fujimoto, K. Ultrafast reversible photo-cross-linking reaction: toward in situ DNA manipulation. Organic Letters 10, pp. 3227-3230 (2008).
[5] Fujimoto, K., Konishi—Hiratsuka, K., Sakamoto, T., Yoshimura, Y. Site—specific photochemical RNA editing. Chemical Communications 46, pp. 7545-7547 (2010).
[6] Shigeno, A., Sakamoto, T., Yoshimura, Y., Fujimoto K. Quick regulation of mRNA functions by a few seconds of photoirradiation. Organic & Biomolecular Chemistry 10, pp. 7820-7825 (2012).
[7] Fujimo, K., Konishi—Hiratsuka, K., Sakamoto, T. Quick, Selective and reversible photocrosslinking Reaction between 5-methylcytosine and 3-cyanovinylcarbazole in DNA double strand. International Journal of Molecular Sciences 14(3), pp. 5765-5774 (2013).
[8] Levskaya, A., Weiner, O. D., Lim, W. A., Voigt, C. A. Spatiotemporal control of cell signalling using a light—switchable protein interaction. Nature 461, pp. 997-1001 (2009).
[10] Texas Instruments (TI) (Posted: August 2012, Rev. Sept. 2012). “DLP9500: DLP® 0.95 1080p 2x LVDS Type A DMD.” Retrieved (Apr. 20, 2013) from: <http://www.ti.com/lit/ds/dlps025a/dlps025a.pdf>.
[11] Hinrichsen, E. L., Feder, J., Jossang, T. Geometry of random sequential adsorption. Journal of Statistical Physics 44(516), pp. 793-827 (1986).
[12] Cadilhe, A., Araujo, N. A. M., Privman, V. Random sequential adsorption: from continuum to lattice and pre-patterned substrates. Journal of Physics: Condensed Matter 19, 065124 (2007).
[13] Torquato, S., Uche, O. U., Stillinger, F. H. Random sequential addition of hard spheres in high Euclidean dimensions. <arXiv:cond-mat/0608402>
[14] Andor Technology (Andor). “iXon EMCCD Camera Series.” Retrieved (Nov. 23, 2013) from: <http://www.andor.com/scientific-cameras/ixon-emccd-camera-series>.
[15] Hamamatsu Corporation. “Digital CMOS camera—ORCA-Flash 4.0 V2 C11440-22CU.” Retrieved (Nov. 23, 2013) from: <http://www.hamamatsu.com/jp/en/community/life_science_camera/product/search/C11440-22CU/index.html>.
[16] Pertsinidis, A., Zhang, Y., S., Subnanometre single-molecule localization, registration and distance measurements. Nature 466, pp. 647-651 (2010).
[17] Piestun, R., Schechner, Y. Y., Shamir, J. Propagation-invariant wave fields with finite energy. Journal of the Optical Society of America A 17, pp. 294-303 (2000).
[18] Betzig, E., Patterson, G. H., Sougrat, R., Lindwasser, O. W., Olenych, S., Bonifacino, J. S., Davidson, M. W., Lippincott-Schwartz, J., Hess, H. F. Imaging intracellular fluorescent proteins at nanometer resolution. Science 313, pp. 1642-1645 (2006).
[19] Pavani, S. R. P., Thompson, M. A., Biteen, J. S., Lord, S. J., Liu, N., Twieg, R. K., Piestun, R., Moerner, W. E. Three-dimensional single-molecule fluorescence imaging beyond the diffraction limit using a double-helix point spread function. PNAS 106, pp. 2995-2999 (2009).
[20] Lee, H. D., Sahl, S. J., Lew, M. D., Moerner, W. E. The double-helix microscope super-resolves extended biological structures by localizing single blinking molecules in three dimensions with Nanoscale precision. Applied Physics Letters 100(15), 153701 (2012).
[21] Backlund, M. P., Lew, M. D., Backer, A. S., Sahl, S. J., Grover, G., Agrawal, A., Piestun, R., Moerner, W. E. Simultaneous, accurate measurement of the 3D position and orientation of single molecules. PNAS 109, pp. 19087-19092 (2012).
[22] Huang, B., Wang, W., Bates, M., Zhuang, X. Three-dimensional super-resolution by stochastic optical reconstruction microscopy. Science 319(5864), pp. 810-813 (2008).
[23] Ram, S., Chao, J., Prabhat, P., Ward, E. S., Ober, R. J. A novel approach to determining the three-dimensional location of microscopic objects with applications to 3D particle tracking Proc. SPIE 6443 (2007).
[24] Juette, M. F., Gould, T. J., Lessard, M. D., Mlodzianoski, M. J., Nagpure, B. S., Bennett, B. T., Hess, S. T., Bewersdorf, J. Three-dimensional sub-100 nm resolution fluorescence microscopy of thick samples. Nature Methods 5(6), pp. 527-529 (2008).
[25] Pavani, S. R. P., Piestun, R. Three dimensional tracking of fluorescent microparticles using a photon-limited double-helix response system. Optics Express 16(26), pp. 22048-22057 (2008).
[26] Middendorff, C. V., Egner., A., Geisler, C., Hell, S. W., Schonle, A. Isotropic 3D nanoscopy based on single emitter switching. Optics Express 16(25), pp. 20774-20788 (2008).
[27] Badieirostami, M., Lew, M. D., Thompson, M. A., Moerner, W. E. Three-dimensional localization precision of the double-helix point spread function versus astigmatism and biplane. Applied Physics Letters 97, 161103 (2010).
[28] Szilard, L. On the decrease of entropy in a thermodynamic system by the intervention of intelligent beings. Zeitschrift fur Physik 53, pp. 840-856 (1929).
[29] Toyabe, S., Sagawa, T., Ueda, M., Muneyuki, E., Sano, M. Experimental demonstration of information-to-energy conversion and validation of the generalized Jarzynski equality. Nature Physics 6, pp. 988-992 (2010).
[30] Vaughan, J. C., Jia, S., Zhuang X. Ultrabright photoactivatable fluorophores created by reductive caging. Nature Methods 9, pp. 1181-1184 (2012).
[31] Olejnik, J., Sonar, S., Krzymailska-Olejnik, E., Rothschild, K. J. Photocleavable biotin derivatives: a versatile approach for the isolation of biomolecules. PNAS 92(16), pp. 7590-7594 (1995).
[33] Dempsey, a T., Bates, M., Kowtoniuk, W. E., Liu, D. R., Tsien, R. Y., Zhuang, X. Photoswitching mechanism of cyanine dyes. Journal of the American Chemical Society 131(51), pp. 18192-18193 (2009).
[34] Dempsey, G., Vaughan, J., Chen, K., Bates, M., Zhuang, X. Evaluation of fluorophores for optimal performance in localization-based super-resolution imaging. Nature Methods 8, pp. 1027-1036 (2011).
[35] Jones, S. A., Shim, S. H., He, J., Zhuang, X. Fast, three-dimensional super-resolution imaging of live cells. Nature Methods 8, pp. 499-505 (2011).
[36] Kalies, S., Kuctemeyer, K., Heisterkamp, A. Mechanisms of high order photobleaching and its relationship to intracellular ablation Biomedical Optics _Express 2(4), pp. 805-816 (2011).
[37] Eggeling, C., Volkmer, A., Seidel, C. A. M. Molecular photobleaching kinetics of Rhodamine 6G by one and two-photon induced confocal fluorescence microscopy. ChemPhysChem 6(5), pp. 791-804 (2005).
[38] Patterson G. I1., Piston D. W. Photobleaching in two-photon excitation microscopy. Biophysical Journal 78(4), pp. 2159-2162 (2000).
[39] Chen, T. S., Zeng, S. Q., Luo, Q. M., Zhang, Z. H., Zhou, W. High order photobleaching of green fluorescent protein inside live cells in two-photon excitation microscopy. Biochem. Biophys. Res. Commun. 291(5), pp, 1272-1275 (2002).
[40] Chen, T. S., Zeng, S. Q., Zhou, W., Luo, Q. M. A quantitative theory model of a photobleaching mechanism. Chinese Physics Letters 20(11), pp. 1940-1943 (2003).
[41] Linde, S. L., Loschberger, A., Klein, T., Heidbreder, M., Wolter, S., Heilemann, M., Sauer, M. Direct stochastic optical reconstruction microscopy with standard fluorescent probes. Nature Protocols 6, pp. 991-1009 (2011).
[42] Dittrich, P. S., Schwille, P. Photobleaching and stabilization of fluorophores used for single-molecule analysis with one- and two-photon excitation. Applied Physics B 73, pp. 829-837 (2001).
[43] Heisterkamp, A., Baumgart, J., Maxwell, I. Z., Ngezahayo, A., Mazur, E., Lubatschowski, H. Fs-laser scissors for photobleaching, ablation in fixed samples and living cells, and studies of cell mechanics. Methods in Cell Biology 82, pp. 293-307 (2007).
[44] Bates, M., Blosser, T. R., Zhuang, X. Short-range spectroscopic ruler based on a single-molecule optical switch. Physical Review Letters 94(10), 108101 (2005).
[45] Bates, M., Huang, B., Dempsey, G. T., Zhuang, X. Multicolor super-resolution imaging with photo-switchable fluorescent probes. Science 317(5845), pp. 1749-1753 (2007).
[46] Conley, N. R., Biteen, J. S., Moerner, W. E. Cy3-Cy5 covalent heterodimers for single-molecule photoswitching. Journal of Physical Chemistry B 112(38), pp. 11878-11880 (2008).
[47] Goemer, H. Direct and sensitized photoprocesses of bis-benzimidazole dyes and the effects of surtfactants and DNA. Photochem. Photobiol. 73, pp. 339-348 (2001).
[48] Reuther, A., Nikogosyan, D. N., Laubereau, A. Primary photochemical processes in thymine in concentrated aqueous solution studied by feratosecond UV spectroscopy. J. Chem. Phys. 100, pp. 5570-5577 (19%).
[49] Epifanovsky, E., Polyakov, I., Grigorenko, B., Nemukhin, A., Krylov, A. I. The effect of oxidation on the electronic structure of the green fluorescent protein chromophore. J. Chem. Phys. 132, 115104 (2010).
[50] Ormo, M., Cubitt, A. B., Kan), K., Gross, L. A., Tsien, R.Y., Remington, S. J. Crystal structure of the Aerquorea victoria green fluorescent protein. Science 273, pp. 1392-1395 (1996). /
[51] Amouyal, E., Bemas, A., Grand, D. On the photoionization energy threshold of tryptophan in aqueous solutions. Photochem. Photobiol. 29, pp. 1071-1077 (1979).
[52] Bisby, R. H., Crisostomo, A. G., Botchway, S. W., Parker, A. W. Nanoscale hydroxyl radical generation from multiphoton ionization of tryptophan. Photochem. Photobiol. 85, pp. 353-357 (2009).
[53] Nikogosyan D. N., Oraevsky A. A., Rupasov V. I. Two-photon ionization and dissociation of liquid water by powerful laser UV radiation. Chem. Phys. 77, pp. 131-143 (1983).
[54] Tirlapur, U. K. Koenig, K., Peuckert, C., Krieg, R., Halbhuber, K. J. Femtosecond near-infrared laser pulses elicit generation of reactive oxygen species in mammalian cells leading to apoptosis-like death. Exp. Cell Res. 263, pp. 88-97 (2001).
[55] Kuetemeyer, K., Rezgui, R., Lubatschowski, H., Heisterkamp, A. Influence of laser parameters and staining on ferntosecond laser-based intracellular nanosurgery. Biomed. Opt. Express 1, pp. 587-597 (2010).
[56] Heilemann, M., Margeat, E., Kasper, R., Sauer, M., Tinnefeld, P. Carbocyanine dyes as efficient reversible single-molecule optical switch. J. Am. Chem. Soc. 127(11), pp. 3801-3806 (2005).
[57] Sabanayagam, C. R., Eid, J. S., Meller, A. Long time scale blinking kinetics of cyanine fluorophores conjugated to DNA and its effect on Förster resonance energy transfer. J. Chem. Phys. 123, 224708 (2005).
[58] Song L., Varma, C. A., Verhoeven, J. W., Tanke, H. J. Influence of the triplet excited state on the photobleaching kinetics of fluorescein in microscopy. Biophysical Journal 70(6), pp. 2959-2968 (1996).
[59] Rasnik, I., McKinney, S. A., Ha, T. Nonblinking and long-lasting single-molecule fluorescence imaging. Nature Methods 3, pp. 891-893 (2006).
[60] Widengren, J., Chmyrov, A., Eggeling, C., Lofdahl , P. A., Seidel, C. A. M. Strategies to improve photostabilities in ultrasensitive fluorescence spectroscopy. J. Phys. Chem. A 111(3), pp. 429-440 (2007).
[61] Tokumura, K., Kurauchi, M., Oyama, 0. Reverse intersystem crossing from higher triplet to excited singlet in 2,2′-bipyridine-3,3′-diol phototautomer. J. Photochem. Photobiol. A 81(3), pp. 151-158 (1994).
[62] Reindl, S., Penzkofer, A. Higher excited-state triplet-singlet intersystem crossing of some organic dyes. Chem. Phys. 211(1-3), pp. 431-439 (1996).
[63] Redmond, R. W., Kochevar, I. E., Krieg, M., Smith, G., McGimpsey, W. G. Excited state relaxation in cyanine dyes: a remarkably efficient reverse intersystem crossing from upper triplet levels. J. Phys. Chem. A 101(15), pp. 2773-2777 (1997).
[64] Rockmann, I., Zeug, A., Herter, R., Roder, B. On the influence of higher excited states on the ISC quantum yield of octa-aL-alkyloxy-substituted Zn-phthalocyanine molecules studied by nonlinear absorption. Photochem. Photobiol. 66, pp. 576-584 (1997).
[65] Ringemann, C., Schonle, A., Giske, A., von Middendorff, C., Hell, S. W., Eggeling C. Enhancing fluorescence brightness: effect of reverse intersystem crossing studied by fluorescence fluctuation spectroscopy. ChemPhysChem 9(4), pp. 612-624 (2008).
[66] Donnert, G., Keller, J., Medda, R., Andrei, M. A., Rizzoli, S. 0., Lurmann, R., Jahn, R., Eggeling, C., Hell, S. W. Macromolecular-scale resolution in biological fluorescence microscopy. PNAS 103(31), pp. 11440-11445 (2006).
[67] Donnert, G., Eggeling, C., Hell, S. W. Major signal increase in fluorescence microscopy through dark-state relaxation. Nature Methods 4, pp. 81-86 (2007).
[68] Zadeh, J. N., Steenberg, C. D., Bois, J. S., Wolfe, B. R., Pierce, M. B., Khan, A. R., Dirks, R. M., Pierce, N. A. NUPACK: analysis and design of nucleic acid systems. Journal of Computational Chemistry 32, pp. 170-173 (2011).
[69] SantaLucia, J. Jr. A unified view of polymer, dumbbell, and oligonucleotide DNA nearest-neighbor thermodynamics. PNAS 95(4), pp. 1460-1465 (1998).
[70] Record, M. T. Jr., Anderson, C. F., Lohman, T. M. Thermodynamic analysis of ion effects on the binding and conformational equilibria of proteins and nucleic acids: the roles of ion association or release, screening, and ion effects on water activity. Q. Rev. Biophys. 11, pp. 103-178 (1978).
[71] Manning, G. S. The molecular theory of polyelectrolyte solutions with applications to the electrostatic properties of polynucleotides. Q. Rev. Biophys. 11, pp. 179-246 (1978).

[72] Petruska, J., Goodman, M. F. Enthalpy-entropy compensation in DNA melting thermodynamics. Journal of Biological Chemistry 270, pp. 746-750 (1995).

1. A method comprising
(i) irradiating, in the presence of a primary thiol containing photoswitching agent, a plurality of fluorescent-competent molecules (dyes) each having a polymethine bridge and an intact pi (π)-conjugated system disposed on a substrate having a first area and a second area, at or near the absorbance/excitation wavelength of the dye molecules, and until no fluorescence is detected from the plurality of fluorescent-competent molecules (dyes),
(ii) irradiating the plurality of fluorescent-competent molecules (dyes) at a wavelength and energy density sufficient to dissociate the primary thiol containing photoswitching agent from on average a single fluorescent-competent molecule (dye) within a diffraction limited area, thereby generating a fluorescent signal from the dissociated fluorescent-competent molecule (dye),
(iii) detecting fluorescent signal from a single dissociated fluorescent-competent molecule (dye) and thereby determining the location of the single dissociated fluorescent-competent molecule (dye) on the substrate,
(iv) irradiating, at high power density and for short duration, the substrate if the single dissociated fluorescent-competent molecule (dye) is located in a second area but not if the single dissociated fluorescent-competent molecule (dye) is located in the first area, and
(v) optionally repeating steps (i) through (iv).

2. The method of claim 1, wherein the fluorescent-competent molecules (dyes) are Cy5, Cy5.5, Cy or Alexa647.

3. The method of claim 1, wherein the primary thiol photoswitching agent is beta-mercaptoethanol, L-Cys-mercaptoethanol or mercaptoethylamine (MEA).

4. The method of claim 1, wherein the fluorescent-competent molecules (dyes) are Cy5 and irradiating in step (i) is carried out at or near 650 nm and irradiating in step (ii) is carried out at a wavelength in the range of about 300 to about 405 nm.

5. The method of claimn 1, wherein the fluorescent-competent molecules (dyes) are Cy5 in proximity to Cy3, and irradiating in step (i) is carried out at or near 650 nm and irradiating in step (ii) is carried out at or near 532 nm.

6. The method of claim 1, wherein fluorescence in step (i) and fluorescent signal in step (iii) is detected using a CCD or EMCCD camera or a CMOS-based detector.

7. The method of claim 1, wherein irradiating in step (iv) is performed using a mode-locked laser system, optionally an actively or a passively mode-locked laser system.

8. The method of claim 1, wherein irradiating in step (iv) is performed using power densities in the range of at or near 100 kW/cm² to at or near 1 MW/cm², or at or near 100 kW/cm² to at or near 1 GW/cm², or at or near 100 kW/cm² to at or near 1 TW/cm².

9. The method of claim 1, wherein irradiating in step (iv) is performed in femtoseconds.

10. The method of claim 1, wherein irradiating in step (i) is performed using a laser, optionally coupled to a DMD array.

11. The method of claim 10, wherein each grid of the DMD array performs a separate parallel STORM process.

12. The method of claim 1, wherein steps (i) and (iv) are repeated until no further fluorescent signal is detected in the second area.

13. The method of claim 12, further comprising
(vi) irradiating the substrate at a wavelength sufficient to dissociate the primary thiol containing photoswitching agent from fluorescent-competent molecules (dyes) in the first area, and removing the dissociated primary thiol containing photoswitching agents, optionally through buffer flow or buffer exchange.

14. The method of claim 13, further comprising
(vii) irradiating, in the presence of a primary thiol containing intermediate or final agent, the substrate at the absorbance/excitation wavelength of the fluorescent-competent molecules (dyes).

15. The method of claim 14, wherein the primary thiol containing intermediate agent comprises a reactive group or binding domain.

16. The method of claim 15, further comprising contacting the substrate with an agent that reacts with the reactive group or an agent that binds to the binding domain.

17. The method of any one of the foregoing claims claim 1, wherein the substrate has a diffraction limited area.

18. The method of claim 1, wherein the first area and/or the second area is a diffraction limited area.

19. The method of claim 1, wherein the method is performed at low temperature.

20-23. (canceled)

24. A method comprising
(i) incubating a plurality of fluorescent-competent molecules (dyes) each having a polymethine bridge and an intact pi (π)-conjugated system disposed on a substrate having a first area and a second area, with a phosphine-based photoswitching/reducing agent, and optionally irradiating at or near the absorbance/excitation wavelength of the dye molecules until no fluorescence is detected from the plurality of fluorescent-competent molecules (dyes),
(ii) irradiating the plurality of fluorescent-competent molecules (dyes) at a wavelength and energy density sufficient to dissociate the phosphine-based photoswitching/reducing agent from on average a single fluorescent-competent molecule (dye) within a diffraction limited area, thereby generating a fluorescent signal from the dissociated fluorescent-competent molecule (dye),
(iii) detecting fluorescent signal from a single dissociated fluorescent-competent molecule (dye) and thereby determining the location of the single dissociated fluorescent-competent molecule (dye) on the substrate,
(iv) irradiating, at high power density and for short duration, the substrate if the single dissociated fluorescent-competent molecule (dye) is located in a second area but not if the single dissociated fluorescent-competent molecule (dye) is located in the first area, and
(v) optionally repeating steps (i) through (iv).

25-44. (canceled)
